(19) United States
(12) Patent Application Publication
(10) Pub. No.: US 2015/0019994 A1
(43) Pub. Date: Jan. 15, 2015

(54) CONTEXTUAL REFERENCE INFORMATION ON A REMOTE DEVICE

(71) Applicant: Apple Inc., Cupertino, CA (US)

(72) Inventors: Marion Freudenthaler, Hamburg (DE); Robert Hunt, San Jose, CA (US); Robert Baker, San Francisco, CA (US)

(73) Assignee: Apple Inc., Cupertino, CA (US)

(21) Appl. No.: 13/940,031

(22) Filed: Jul. 11, 2013

(51) Int. Cl. G06F 3/0484

(52) U.S. Cl. CPC G06F 3/04842
USPC 715/748

(57) ABSTRACT

Systems and methods for displaying reference information on a remote device that corresponds to a control element displayed on a host device are provided. A system and method can include displaying one or more control elements of a user interface and a selection element by a host device. An input can be received corresponding to moving the selection element onto a control element. An identifier of the control element can be determined, and then transmitted to a remote device. When received by the remote device, the identifier can be used to identify and display reference information corresponding to the control element.

### BACKGROUND

The present disclosure relates generally to computing devices and more particularly to a remote device displaying reference information corresponding to a control element displayed on a host device.

Computing devices such as desktop computers and mobile devices (e.g., laptop computers, smart phones, tablet computers, media players, and the like) have become quite popular and play an integral role in our day-to-day lives. For instance, many users carry a computing device almost everywhere they go and use their devices for a variety of purposes, including sending, receiving, and managing text messages and emails, viewing maps, navigation (e.g., using such maps and/or a GPS receiver), purchasing items in stores (e.g., using contactless payment systems), making and receiving phone calls, and/or accessing the Internet (e.g., to look up information). To facilitate such functionality, computing devices typically utilize an operating system that can run various types of applications.

Operating systems and applications typically include a user interface with control elements that a user can select, or otherwise interact with. Such interaction can cause a computing device to perform various functions of the operating system or application, and particularly those function(s) associated with the selected control element. In many instances, however, users may be unaware of the specific functionalities associated with some or all of the control elements displayed in a user interface. Thus, in such instances, users may be unable to utilize otherwise desirable functionalities provided by the operating system or applications running on their device. Users can perform a “trial by error” process whereby control elements are randomly selected by the user to determine their functionality. Such a process, however, can be quite time consuming and ineffective.

In many instances, an operating system or application may be associated with an installed user manual that includes reference information describing the functionality of the various control elements displayed within the relevant user interface. A displayed user manual, however, may occupy all or a significant portion of a computing device's display area, and thus may obstruct the underlying user interface. Such obstruction may prevent a user from utilizing functionalities of the operating system or application while the user manual is being displayed.

### SUMMARY

Certain embodiments of the invention are directed to a remote device displaying reference information corresponding to a control element displayed on a host device.

In some embodiments, a host device can display one or more control elements of a user interface and a selection element. Input corresponding to moving the selection element onto a control element can be received, and an identifier of the control element can be determined. In some embodiments, the identifier can be a tag embedded within the control element. The identifier can be transmitted from the host device to a remote device. When received by the remote device, the identifier of the control element can be used by the remote device to identify and display reference information corresponding to the control element.

In some embodiments, the remote device can identify the reference information by cross-referencing the identifier received from the host device with reference information stored in a database. The displayed reference information can include content relating to the functionality of the control element, including multimedia content.

In some embodiments, prior to transmitting the identifier of the control element to the remote device, the host device can establish a communication link with the remote device. Such a communication link can be, for instance, a wireless communication link. In some embodiments, prior to establishing the communication link, the remote device can identify and display one or more host devices (including the host device) with which a communication link can be made. For instance, the remote device can display a list of available host devices in response to receiving input corresponding to initiating a reference information mode of an application being executed by the remote device. Upon receiving an input corresponding to a selection of the host device, the communication link can be established. In some embodiments, the communication link can be a wired communication link established across a cable (e.g., an Ethernet connection).

In some embodiments, the control element may be a first control element, and after transmitting the identifier of the first control element to the remote device, the host device may receive an input corresponding to moving the displayed selection element onto a second control element. An identifier of the second control element can be determined, and then transmitted to the remote device. The identifier of the second control element can be used by the remote device to identify and display reference information corresponding to the second control element. In some embodiments, the remote device may receive an input corresponding to initiation of a screen lock mode that causes the remote device to maintain the display of the reference information corresponding to the first control element upon receiving the identifier of the second control element from the host device.

### BRIEF DESCRIPTION OF THE DRAWINGS

FIGS. 1-13B illustrate examples of techniques for displaying reference information on a remote device, the reference information corresponding to a control element displayed on a host device according to some embodiments;

FIG. 14 illustrates a simplified diagram of a system that may incorporate one or more embodiments of the invention;

FIG. 15 illustrates a simplified diagram of a distributed system that may incorporate one or more embodiments of the invention;

FIG. 16 illustrates a simplified flowchart depicting a method of displaying reference information on a remote device, the reference information corresponding to a control element displayed on a host device according to some embodiments;

FIG. 17 illustrates a simplified flowchart depicting a method of displaying reference information on a remote device, the reference information corresponding to a second control element displayed on a host device according to some embodiments;

FIG. 18 illustrates a simplified block diagram of a computer system that may incorporate components of a system for displaying reference information on a remote device, the reference information corresponding to a control element displayed on a host device according to some embodiments.

### DETAILED DESCRIPTION

In the following description, for the purposes of explanation, specific details are set forth in order to provide a thorough understanding of embodiments of the invention. However, it will be apparent that various embodiments may be practiced without these specific details.

Certain embodiments of the invention are directed to a remote device displaying reference information corresponding to a control element displayed on a host device.

The host device can be any suitable computing device. For instance, the host device can be a desktop computer. In some embodiments, the host device can be a mobile computing device such as a laptop computer, tablet computer, smart phone, media player, or the like.

In some embodiments, the host device can display one or more control elements of a user interface. The one or more control elements may be graphical user interface (GUI) elements that each correspond to a particular functionality. In some embodiments, some or all of the displayed control elements may correspond to functionalities of an application being executed by the host device. In some embodiments, some or all of the displayed control elements may not be tied to a particular application. For instance, any of the one or more control elements may correspond to an application-independent functionality of an operating system running on the host device.

The host device can further display a selection element that may be used to select, or otherwise interact with, the one or more control elements displayed in the user interface. For instance, the selection element can be a GUI element such as a pointer or cursor that can be moved about the user interface in response to received input such as mouse input, trackpad input, voice input, eye gaze input, or the like.

In some embodiments, input can be received by the host device, the input corresponding to moving the selection element onto a control element. For instance, a user can utilize a pointing device such as a mouse or trackpad to move a pointer about the user interface until the pointer is overlapping (e.g., hovering over) the control element. In response to the received input, the host device can determine an identifier of the particular control element. In some embodiments, the identifier can be a tag that is embedded within, and uniquely identifies, the control element. Upon determining the identifier of the control element, the host device can transmit the identifier to a remote device.

The remote device can be any suitable computing device. For instance, in some embodiments, the remote device can be a mobile computing device such as a tablet computer, smart phone, media player, laptop computer, and the like. The remote device may also be a desktop computer in some embodiments.

In some embodiments, the identifier transmitted by the host device can be used by the remote device to identify and retrieve reference information corresponding to the control element. For instance, the remote device can cross-reference the identifier with reference information stored in a database. Such a database can be stored locally in a memory of the remote device. In some embodiments, the database storing the reference information can be stored at a location external to the remote device, such as a web-based server computer accessible via the Internet, a mobile data network, or the like.

The stored reference information can include content relating to the functionality of the control element. For instance, the reference information can include one or more user manuals that provide information regarding the functionality of control elements associated with the applications (and/or operating systems) that are installed on and/or otherwise executable by the host device. Upon receipt of the identifier of the control element from the host device, the remote device can cross-reference the identifier with the stored reference information to identify the relevant portions of the user manual that pertain to the particular control element.

Upon retrieving the reference information corresponding to the control element, the reference information can be displayed by the remote device. As described above, the reference information can include a relevant portion of a user manual that pertains to the control element. In some embodiments, the reference information can be displayed as text-based content and, in some embodiments, the reference information can be displayed as multimedia content such as audio, video, images, and/or the like. The displayed reference information can further include links (e.g., hyperlinks) to additional content relating to the functionality of the control element.

In some embodiments, after transmitting the identifier of the control element to the remote device, the host device can receive an input corresponding to moving the selection element onto a different control element of the displayed user interface. For instance, the user can provide input to move a pointer from the first control element onto a second control element. As with the first control element, the host device can then determine an identifier of the second control element such as a unique tag embedded within the second control element. The determined identifier can be transmitted by the host device to the remote device. Upon receipt, the remote device can cross-reference the identifier with the reference information stored in the database to identify reference information corresponding to the second control element. Such reference information (e.g., portions of the user manual that pertain to the second control element) can then be displayed by the remote device.

In some embodiments, the remote device can include a screen lock mode that causes the display of reference information for one control element to be maintained upon receipt of a subsequent identifier for another control element. For instance, while the reference information corresponding to the first control element is displayed, the remote device can receive an input corresponding to an initiation of the screen lock mode. Such an input may involve the user selecting a button or other user interface element by way of a mouse, trackpad, touchscreen, or any other suitable input device. In response to the received input, the remote device can initiate the screen lock mode. When in this mode, in some embodiments, the remote device can maintain the display of the reference information corresponding to the first control element. Thus, if the identifier corresponding to the second control element, as described above, is received by the remote device when the screen lock mode is activated, the remote device can maintain the display of the reference information corresponding to the first control element instead of retrieving and displaying the reference information corresponding to the second control element.

In some embodiments, a communication link can be established between the host device and remote device to facilitate the transmission of control element identifiers. In some embodiments, the communication link can be a wireless communication link that utilizes WiFi, Bluetooth, or the like. The communication link can also be a wired communication link established via a cable in some embodiments. The communication link between the host device and remote device can be established via an initial “pairing” process that is described in further detail below.

In various embodiments, the remote device can display reference information corresponding to a control element displayed on the host device. By displaying such reference information on the remote device instead of the host device, the display area of the host device can be unobstructed. Thus, the functionalities of the application and/or operating system being executed by the host device can be unaffected. Moreover, by use of the transmitted identifier, the reference information can be immediately displayed to the user by the remote device in response to the user moving the selection element onto the corresponding control element displayed by the host device. Thus, users can be provided with information about the functionality of a control element in a quick and convenient manner, thereby reducing the need for a “trial by error” approach.

As used herein, a “control element” may refer to a user interface element (e.g., a GUI element) that is displayed within a user interface by a computing device (e.g., a host device) and that is associated with a particular functionality. A control element may be selected, viewed, or otherwise interacted with by a user. A control element can be associated with a functionality of an application running on a computing device. A control element can also be application-independent. For instance, a control element can be associated with a functionality of an operating system that is running on a computing device and that facilitates the execution of applications installed on or otherwise accessible to the computing device. A control element can be a button, slider, virtual knob, drown-down list, window, hyperlink, text box, scrollbar, toolbar, taskbar, list box, combo box, check box, radio button, cycle button, datagrid, menu link, tab, input field, or any other element that is displayed in a user interface, and that can be selected, viewed, or otherwise interacted with by a user.

As used herein, a “selection element” may refer to a user interface element (e.g., a GUI element) that can be moved about a user interface in response to received input. A selection element can be a pointer, a cursor, or any other moveable user interface element that can be moved in response to input such as mouse input, trackpad input, voice input, eye motion (eye and/or gaze tracking), and the like. In some embodiments, a selection element can be used to select, or otherwise interact with, one or more control elements displayed in a user interface.

As used herein, “reference information” may refer to any suitable information relating to a control element. For instance, reference information can relate to the functionality of a control element displayed in a user interface. In some embodiments, reference information can include a user manual for an application and/or operating system. Such reference information can further include the relevant portions (e.g., pages, chapters, etc.) of a user manual that pertain to a particular control element. Reference information can include a name and/or description of a control element, instructions for utilizing the functionality of the control element (e.g., a tutorial), a description of the result of selecting or otherwise interacting with the control element, information about related control elements and/or functionalities, and the like. In some embodiments, reference information can include text-based content, and can include multimedia content such as audio, video, images, and the like. Reference information can also include links (e.g., hyperlinks) to additional content relating to the functionality of a control element and/or one or more related control elements.

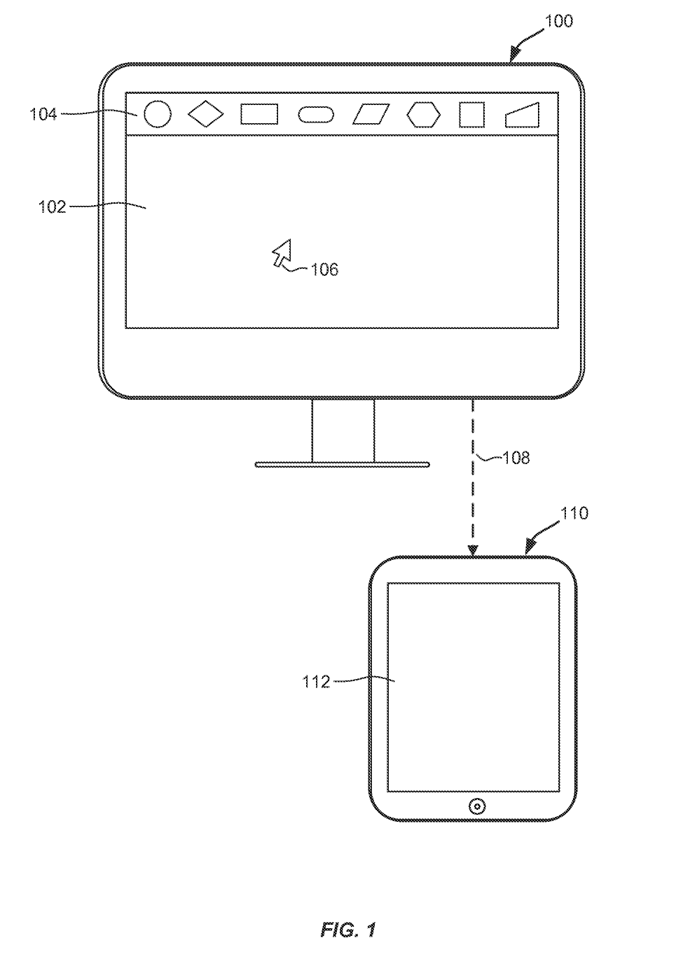

FIGS. 1-13B illustrate examples of techniques for displaying reference information on a remote device, the reference information corresponding to a control element displayed on a host device according to some embodiments. The examples depicted in FIGS. 1-13B are not intended to be limiting.

In FIGS. 1-9, a host device 100 is shown displaying a user interface 102 of an application being executed by host device 100. As further shown in FIGS. 1-9, user interface 102 can include one or more control elements 104 that may each correspond to a particular functionality of the application. In various embodiments, the application being executed by host device 100 can be any suitable application. For instance, exemplary applications may include, without limitation, digital audio workstations (DAWs), word processors, text editors, message applications (e.g., e-mail, SMS, voice, etc.), web browsers, calendar applications, news applications, games applications, media playback and/or editing applications, social network applications, productivity application, sports applications, travel applications, weather applications, entertainment applications, photo editing applications, utility applications, map applications, search engine interfaces, source code editors, database query tools, command line interpreters, and the like. In some embodiments, control elements 104 may be application-independent. For instance, control elements 104 displayed in user interface 102 can be associated with an operating system running on host device 100.

A remote device 110 is further shown in FIGS. 1-9. Remote device 110 can display a user interface 112 of an application being executed by remote device 110. In some embodiments, the application being executed by remote device 110 may be the same application being executed by host device 100. The application being executed by remote device 110 can also be an application that is related to, complimentary to, or a “lite” version of an application being executed by host device 100. Host device 100 and remote device 110 may also execute different applications. For instance, remote device 110 can execute a general help application that provides reference information corresponding to control elements 104 of any suitable application being executed by host device 100. In some embodiments, user interface 112 may correspond to an operating system running on remote device 110. Such an operating system can be the same or similar to (e.g., a lite version of) an operating system running on host device 100.

As further shown in FIGS. 1-9, a communication link 108 can be established between host device 100 and remote device 110. Communication link 108 can be a wireless communication link that utilizes WiFi, Bluetooth, or the like. In some embodiments, communication link 108 can involve a wired connection established via a cable or other connector. As described in further detail below, communication link 108 can facilitate the transmission of identifiers for control elements 104 from host device 100 to remote device 110.

In some embodiments, communication link 108 can be established using a pairing process. For instance, to initiate a pairing process, a reference information mode can be activated on remote device 110. In some embodiments, a user can select a button or other GUI element displayed in user interface 112 of remote device 110 to activate the reference information mode. Such an input may be received via a touchscreen, trackpad, mouse, or any other suitable input device. In response to the received input, remote device 110 can activate the reference information mode.

In some embodiments, upon activation of the reference information mode, remote device 110 can scan for and identify available host devices with which communication link 108 can be established. For instance, if remote device 110 is connected to a wireless network via WiFi, remote device 110 can scan the network to identify any host devices that are also connected to the network and that are available for pairing. If more than one host device is detected, in some embodiments, remote device 110 can display a list of available host devices. In such embodiments, a user may provide input to remote device 110 corresponding to a selection of a host device (i.e. host device 100) for pairing. In some embodiments, the input can cause communication link 108 to be established. In some embodiments, to authenticate the pairing of host device 100 with remote device 110, host device 100 can display a prompt requesting confirmation of the pairing. If input is received corresponding to user confirmation of the pairing, in some embodiments, communication link 108 can be established between host device 100 and remote device 110.

In some embodiments, the availability of host device 100 for pairing may depend on an application currently being executed by host device 100. For instance, when remote device 110 scans for available host device, in some embodiments, only host devices executing the same (or related) application as remote device 110 may be considered available for pairing. In some embodiments, if remote device 110 is executing a general help application that is compatible with a multiple applications, remote device 110 can consider a host device as available if it is currently executing one or more of the compatible applications.

Further, in some embodiments, the pairing process described above may only be performed once to establish communication link 108 between host device 100 and remote device 110. In such embodiments, communication link 108 can subsequently be established automatically in some circumstances. For instance, if remote device 110 detects that it is connected to the same network as host device 100 (or vice versa), communication link 108 can be established automatically without receiving further input at either device. In some embodiments, communication link 108 can be established automatically in response to the reference information mode being activated at remote device 110 when remote device 110 and host device 100 are connected to the same network.

As further shown in FIG. 1, host device 100 can display a selection element 106. In some embodiments, selection element 106 may be used to select, or otherwise interact with, control elements 104 displayed in user interface 102. In FIG. 1, selection element 106 is illustrated as a pointer. However, this is not intended to be limiting. In various embodiments, selection element 106 can be a cursor or any other suitable user interface element that can be moved about user interface 102 in response to received input.

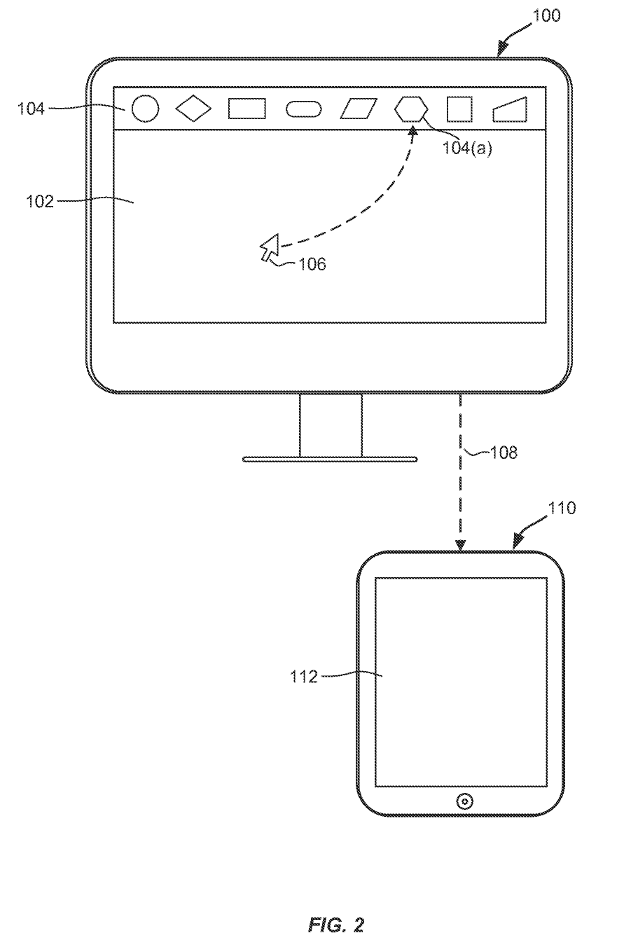

In FIG. 2, a user may desire reference information corresponding to one or more of control elements 104 displayed in user interface 102. For instance, the user may want to review content relating to the functionality of a particular control element 104(a). As depicted in FIG. 2, to initiate the retrieval and display of such reference information, input corresponding to moving selection element 106 onto control element 104(a) can be provided to host device 100. Such input can be provided by the user by way of a mouse, trackpad, or any other suitable input device.

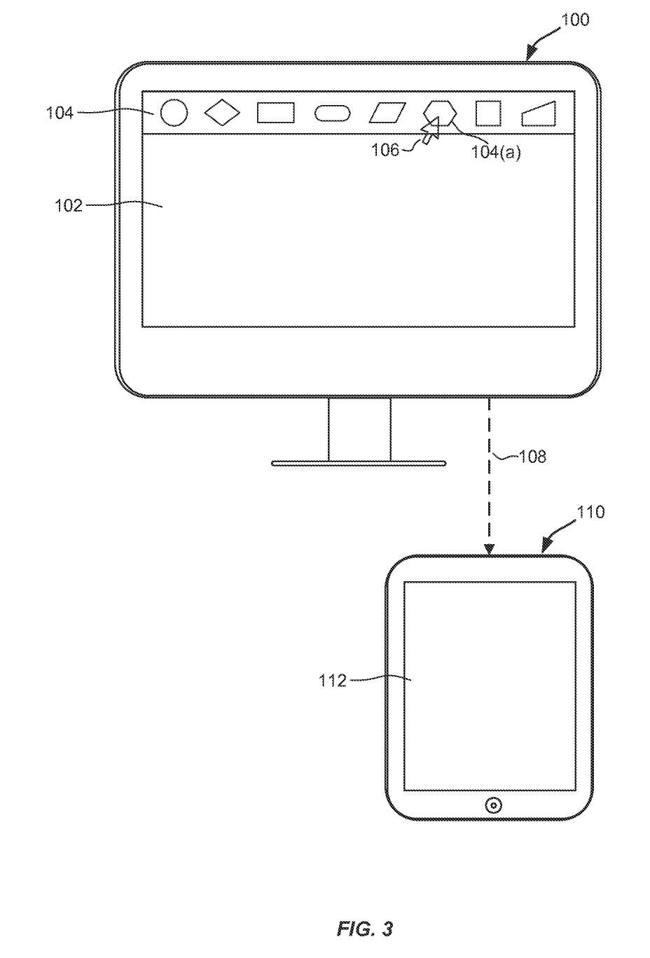

As illustrated in FIG. 3, selection element 106 has been moved onto control element 104(a). As described herein, moving selection element 106 “onto” a control element can include moving selection element 106 over a control element such that at least a portion of selection element 106 overlaps the control element. As shown in FIG. 3, the graphical rendering of such overlap can provide the appearance that selection element 106 is “hovering” over control element 104(a). In some embodiments, moving selection element 106 onto a control element can include moving selection element 106 to a location in the vicinity of the control element so that the elements are adjacent to each other but not overlapping.

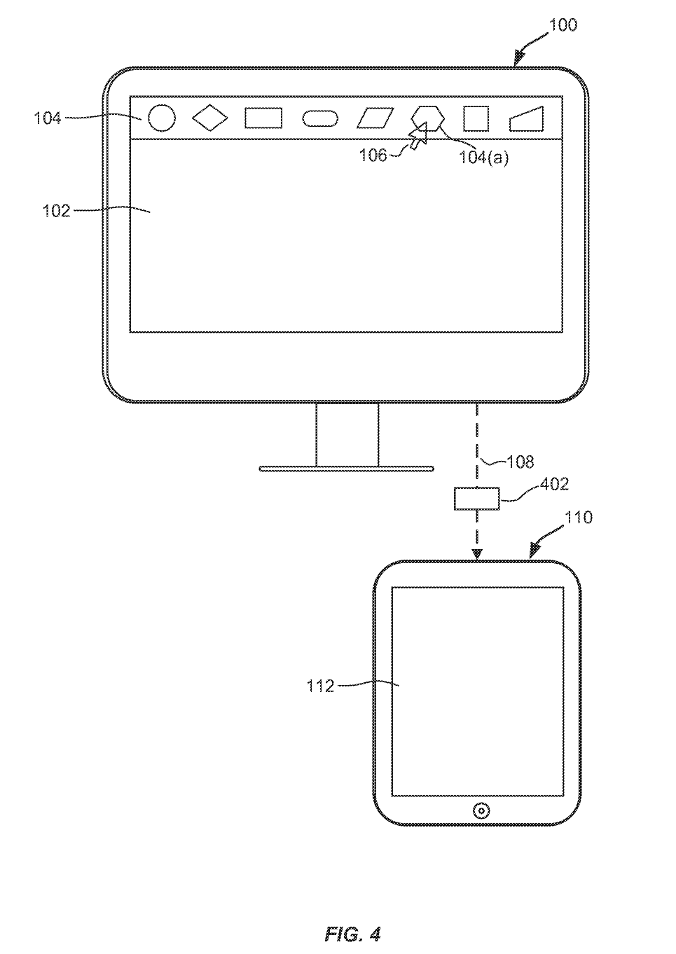

In FIG. 4, upon receiving the input corresponding to moving selection element 106 onto control element 104(a), an identifier 402 for control element 104(a) can be determined by host device 100. Identifier 402 can then be transmitted by host device 100 to remote device 110 via communication link 108.

In some embodiments, identifier 402 of control element 104(a) can be a tag that is embedded within, and identifies, control element 104(a). In some embodiments, determining identifier 402 can include identifying a location (e.g., one or more coordinates) of control element 104(a) in user interface 102, and then cross-referencing the location with a table of identifiers stored in a database to retrieve identifier 402 of control element 104(a). In some embodiments, identifier 402 can be a character string that is looked up in a data table. For instance, such a character string can be retrieved from a property list file (e.g., a Plist file) stored on or otherwise accessible to host device 100. In some embodiments, identifier 402 can further identify an application and/or operating system to which control element 104(a) corresponds.

All or a portion of control elements 104 can be associated with unique identifiers. In some embodiments, identifier 402 can uniquely identify control element 104(a). For instance, if control element 104(a) is associated with an application, identifier 402 can be unique with respect to all the identifiers for control elements associated with the application (e.g., control elements 104). Identifier 402 can also be unique with respect to control elements of multiple applications (e.g., a set of related applications), and in some circumstances “globally” unique across all applications installed or otherwise executable by host device 100.

In some embodiments, host device 100 can display control elements in a layered arrangement. For instance, control elements 104 of user interface 102 can be displayed in another control element such as a toolbar. Further, a toolbar including control elements 104 can be displayed within another control element such as a window. If all or a portion of control elements 104, the taskbar, and the window are each associated with a unique identifier, determining the identifier for the appropriate control element can be accomplished in a number of different ways according to various embodiments. In some embodiments, a hierarchical approach can be used where control elements in “top-most” layers of user interface 102 are favored over control elements in “bottom-most” layers. In such embodiments, if control elements 104 are displayed within a toolbar that is further displayed within a window, in response to selection element 106 being moved over control element 104(a), host device 100 can identify control element 104(a) as the appropriate control element since control element 104(a) is displayed in the top-most layer of user interface 102. Host device 100 can then retrieve and transmit identifier 402 of control element 104(a) to remote device 110.

In some embodiments, selection element 106 can be moved over a control element that is not associated with an identifier (e.g., a control element that does not include an embedded tag). Using a hierarchical approach, host device 100 can determine whether underlying control elements in “bottom-most” or “lower” layers are associated with identifiers. For instance, if the control element without an identifier is displayed within a toolbar that is associated with an identifier, host device 100 can retrieve and transmit the identifier for the toolbar to remote device 110. Similarly, if the toolbar also does not include an identifier but is displayed within a window that does have an identifier, host device 100 can retrieve and transmit the identifier for the window to remote device 110. In various embodiments, a hierarchical approach can be used to determine an identifier of a control element that is included in any suitable layering of control elements in user interface 102.

As described above, upon determining identifier 402 of control element 104(a), host device 100 can transmit identifier 402 to remote device 110 via communication link 108. Identifier 402 can then be used by remote device 110 to identify and retrieve reference information corresponding to control element 104(a). In some embodiments, host device 110 can cross-reference identifier 402 with reference information stored in a database (e.g., an internal and/or external storage) to identify the reference information corresponding to control element 104(a). In some embodiments, reference information stored in the database can be identified and retrieved using a resource identifier such as a uniform resource locator (URL). For instance, a URL can include a character string that identifies the storage location of the reference information in the database. As described above, in some embodiments, identifier 402 can include a unique character string. Thus, in some embodiments, cross-referencing identifier 402 with the corresponding reference information can include appending a URL with the character string received from host device 100. In such embodiments, the URL with the appended character string (i.e. identifier 402) can direct host device 110 to the storage location where the reference information corresponding to control element 104(a) can be retrieved.

As described above, in some embodiments, identifier 402 can identify an application and/or operating system for which control element 104(a) corresponds. In some embodiments, if remote device 110 is executing a general help application that facilitates the retrieval of reference information for multiple applications executable by host device 100, identifier 402 can be cross-referenced with stored reference information that specifically corresponds to the particular application and/or operating system.

The stored reference information can include content relating to the functionality of various control elements, including control element 104(a). For a given control element, the reference information can include a name and/or description of the control element, instructions for utilizing the functionality of the control element, a description of the result of selecting or otherwise interacting with the control element, information about related control elements and/or functionalities, and the like. In some embodiments, the reference information can be stored in the form of a data table that directly maps each control element identifier with the reference information that corresponds to the control element. For instance, the stored reference information can include one or more user manuals that provide information relating to the functionality of control elements associated with the applications (and/or operating systems) that are installed on and/or otherwise executable by the host device. Thus, if control element 104(a) is associated with a particular application, remote device 110 can cross reference identifier 402 with the user manual for the application to identify the relevant portions (e.g., pages, chapters, etc.) that pertain to control element 104(a). It should be noted, however, that reference information as described herein is not limited to information included in a user manual, and that the reference information retrieved by remote device 110 can include any suitable help content or other information that relates to control elements.

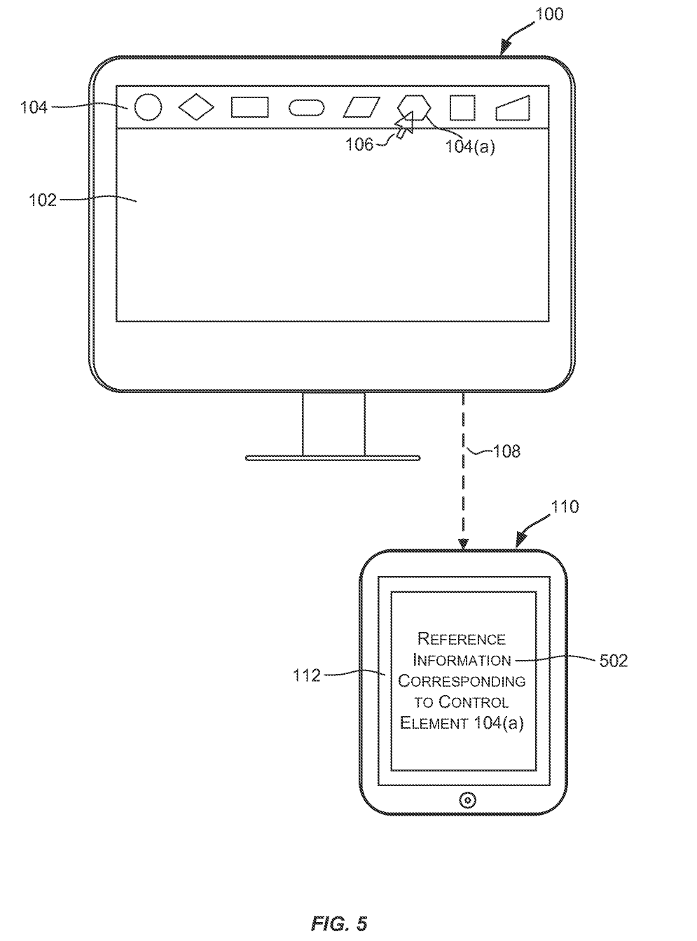

As illustrated in FIG. 5, remote device 110 can identify and display reference information 502 corresponding to control element 104(a) in user interface 112. The displayed reference information 502 can include many different types of content according to various embodiments. For instance, reference information 502 can displayed as text-based content relating to control element 104(a) such as a description of control element 104(a), step-by-step instructions for utilizing control element 104(a) (e.g., a tutorial), a description of the result of selecting or otherwise interacting with control element 104(a)), or any other suitable information. Such text-based content can also provide information about other related control elements and/or functionalities. In some embodiments, reference information 502 can include multimedia content such as audio, video, images, and the like. Reference information 502 can also include one or more links (e.g., hyperlinks) to additional content relating to control element 104(a).

In some embodiments, host device 100 can transmit identifier 402 to remote device 110 immediately upon detecting that selection element 106 has been moved onto control element 104(a). In such embodiments, the time that elapses between the movement of selection element 106 onto control element 104(a) and the display of reference information 502 can simply be the sum of the processing time of host device 100, the transmission time of identifier 402, and the processing time of remote device 110. In other embodiments, identifier 402 can be determined and/or transmitted by host device 100 after a time delay. For instance, prior to transmitting identifier 402, host device may require that selection element 106 be fixed (e.g., hovering) over control element 104(a) for a predetermined interval of time. Such a time delay can avoid the display of reference information in response to the user briefly and inadvertently moving selection element 106 onto a control element for which no reference information is desired.

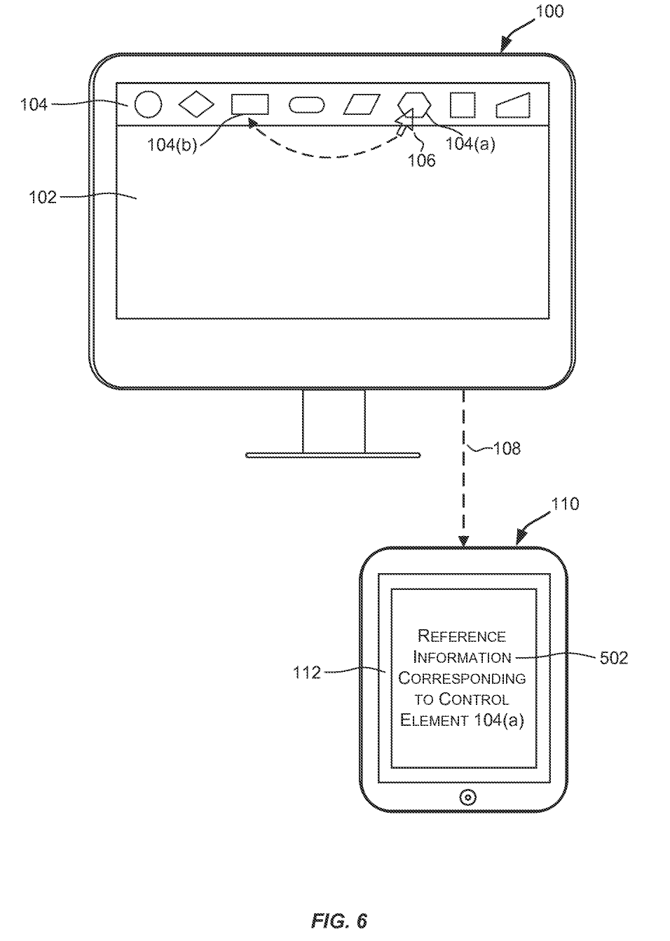

In some embodiments, when reference information 502 corresponding to control element 104(a) is being displayed by remote device 110, the user may want to review reference information corresponding to a different control element. For instance, as shown in FIG. 6, the user many want to review reference information corresponding to control element 104(b) currently displayed in user interface 102 by host device 100. As depicted in FIG. 6, to initiate the retrieval and display of such reference information, input corresponding to moving selection element 106 onto control element 104(b) can be provided to host device 100. As described above, such input can be provided using any suitable input device.

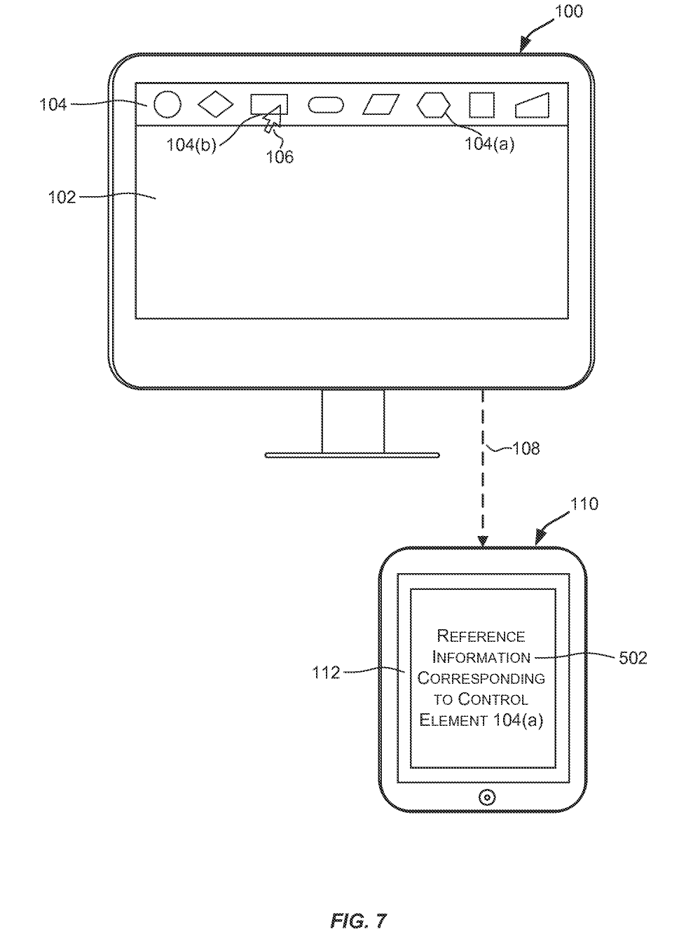

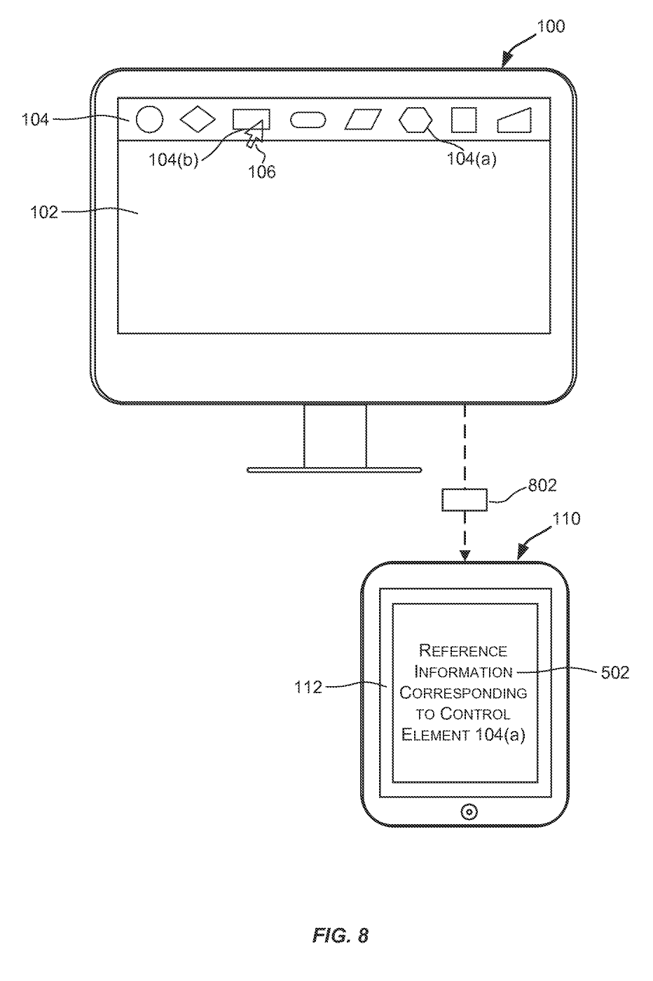

In FIG. 7, selection element 106 has been moved onto control element 104(b). In response to this input, as illustrated in FIG. 8, an identifier 802 for control element 104(b) can be determined by host device 100, and then transmitted to remote device 110 via communication link 108. Identifier 802 of control element 104(b) can be determined as described above with respect to the determination of identifier 402 of control element 104(a).

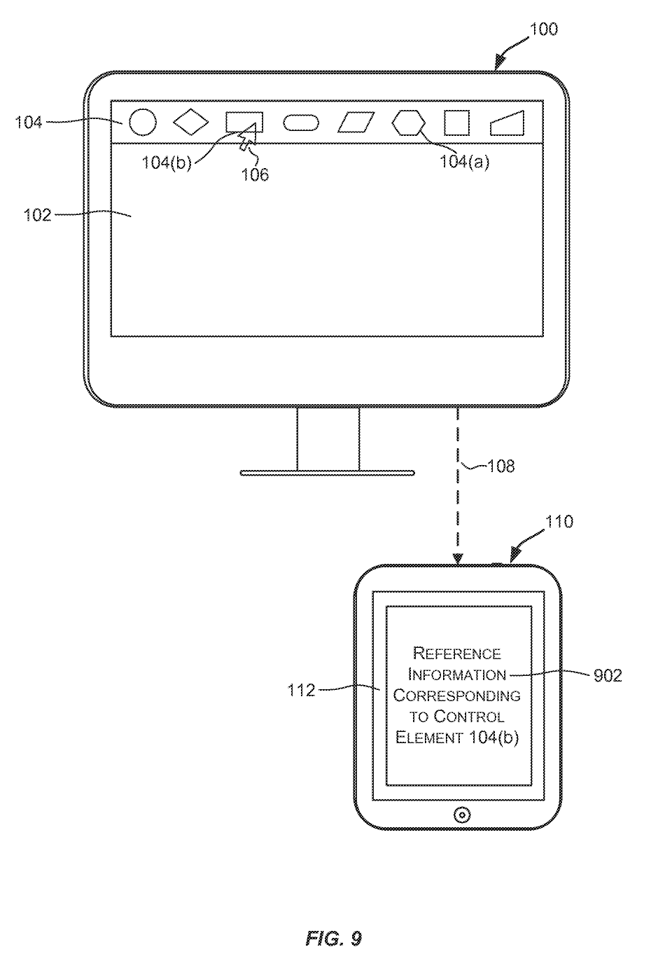

Using identifier 802, remote device 110 can identify and retrieve reference information 902 corresponding to control element 104(b) and, as shown in FIG. 9, reference information 902 can be displayed by remote device 110 in user interface 112. In some embodiments, reference information 902 can replace reference information 502 previously displayed by remote device 110. In some embodiments, reference information 902 and reference information 502 can be displayed simultaneously (e.g., using a split-screen arrangement) in user interface 112. For instance, a particular mode can be activated on remote device 110 that allows for the simultaneous display of reference information corresponding to two, three, or any other suitable number of control elements 104.

As described above with respect to control element 104(a), host device 100 can transmit identifier 802 to remote device 110 immediately upon detecting that selection element 106 has been moved onto control element 104(b). In such embodiments, the time that elapses between the movement of selection element 106 onto control element 104(b) and the display of reference information 902 can simply be the sum of the processing time of host device 100, the transmission time of identifier 802, and the processing time of remote device 110. In other embodiments, host device 100 can transmit identifier 802 to remote device 110 only if selection element 106 is fixed (e.g., hovering) over control element 104(b) for a predetermined period of time.

As illustrated in FIGS. 6-8, in some embodiments, the display of reference information 502 corresponding to control element 104(a) can be maintained by remote device 110 when selection element 106 is moved away from control element 104(a). Thus, reference information 502 can be displayed until it is replaced by reference information 902 corresponding to control element 104(b). In other embodiments, when selection element 106 is moved away from control element 104(a), remote device 110 can display a blank screen or default content in user interface 112. The blank screen or default content can then be replaced by reference information 902 corresponding to control element 104(b).

In some embodiments, remote device 110 can include a screen lock mode that causes the display of reference information for one control element to be maintained upon receipt of a subsequent identifier for another control element. The screen lock mode can be activated by remote device 110 in response to received input. For instance, user interface 112 can include a button or other element that can be selected by the user via any suitable form of input (e.g., touch, mouse, trackpad, voice, eye gaze, etc.). The user interface element used to activate the screen lock mode can be displayed by remote device 110 in any suitable user interface such as a help menu, and screen lock mode can also be activated by way of a physical button integrated within remote device 110. If identifier 802 of control element 104(b) is received by remote device 110 when the screen lock mode is activated, remote device 110 can continue to display reference information 502 corresponding to control element 104(a) instead of replacing it with reference information 902 corresponding to control element 104(b).

In some embodiments, remote device 110 can be one of a plurality of remote devices that are communicatively coupled to host device 100. For instance, host device 100 can be paired with the remote devices such that host device 100 can transmit identifiers of control elements to the remote devices over one or more communication channels using WiFi, Bluetooth, or any other suitable communication protocol. As a non-limiting example, such embodiments may provide advantages in a classroom setting. In this example, an instructor can move selection element 106 onto a control element displayed by host device 100. Host device 100 can then determine an identifier for the control element, and simultaneously transmit the identifier to the plurality of remote devices which may each be operated by a student in the classroom. Upon receipt, the remote devices can identify and display reference information corresponding to the control element.

In some embodiments, host device 100 and/or remote device 110 can determine whether identifiers of control elements are appropriately “linked” to corresponding reference information. For instance, when an application is upgraded or otherwise changed, new control elements can be added, existing control elements can be removed, etc. In some embodiments, upon such changes to an application, host device 100 and/or remote device 110 can perform a process whereby the existence of reference information corresponding to the control elements may be confirmed, and the links between identifiers and corresponding reference information verified. In some embodiments, such a process can also be performed in response to changes in the stored reference information (e.g., a user manual update). In some embodiments, links between reference information and control element identifiers can be checked and verified on a periodic basis. In some embodiments, such links can be checked and verified when an application (or application update) is built and/or compiled. For instance, when an application installable on host device 100 is being built and/or compiled, an alert or error message can be generated when a control element associated with the application is not appropriately linked to the corresponding reference information installable or otherwise accessible to remote device 110.

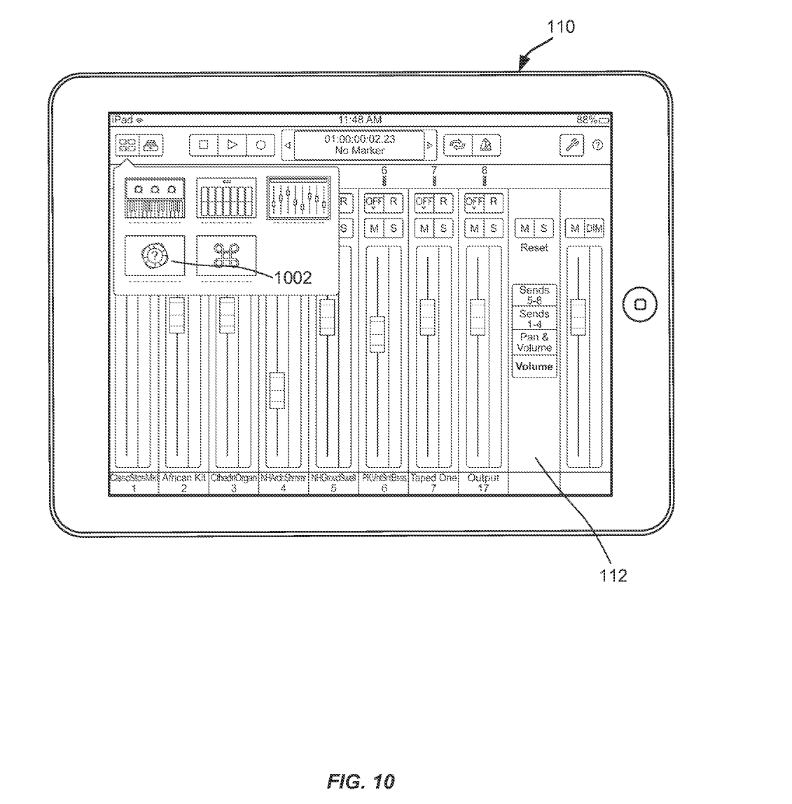

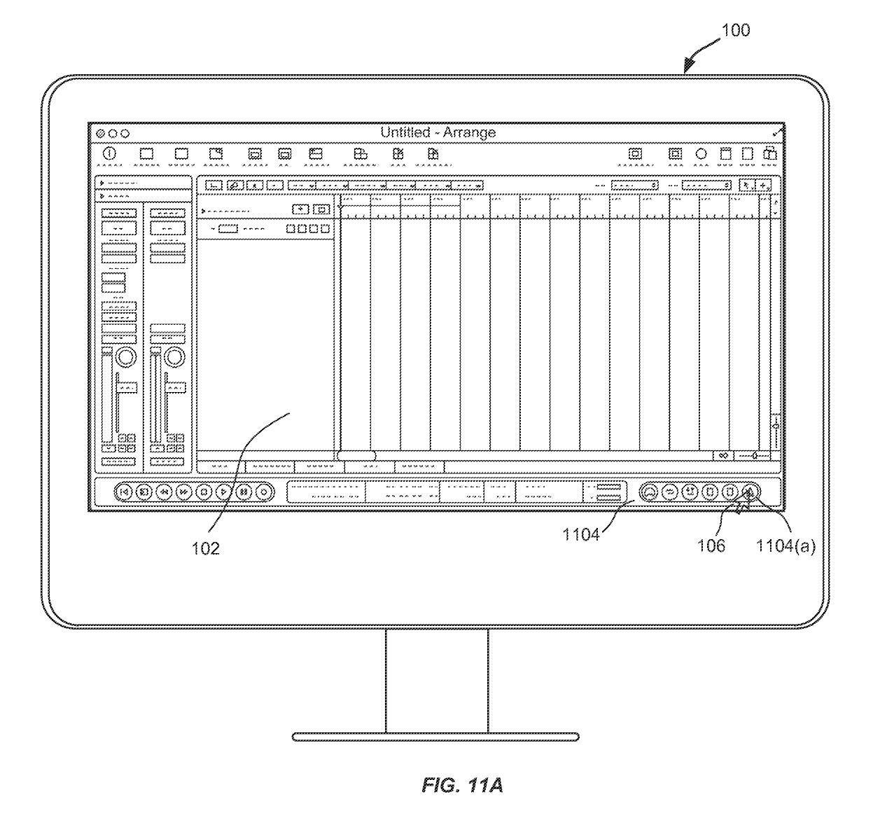

FIGS. 10-13B depict specific examples of remote device 110 displaying reference information corresponding to a control element being displayed on host device 100 in the context of particular applications and/or operating systems. These examples are intended to be non-limiting. As described above, in various embodiments, reference information can be provided in the context of any suitable application or operating system.

As described above, in some embodiments, to establish a communication link between host device 100 and remote device 110, a reference information mode can be activated at remote device 110. FIG. 10 illustration an exemplary user interface for activating the reference information mode.

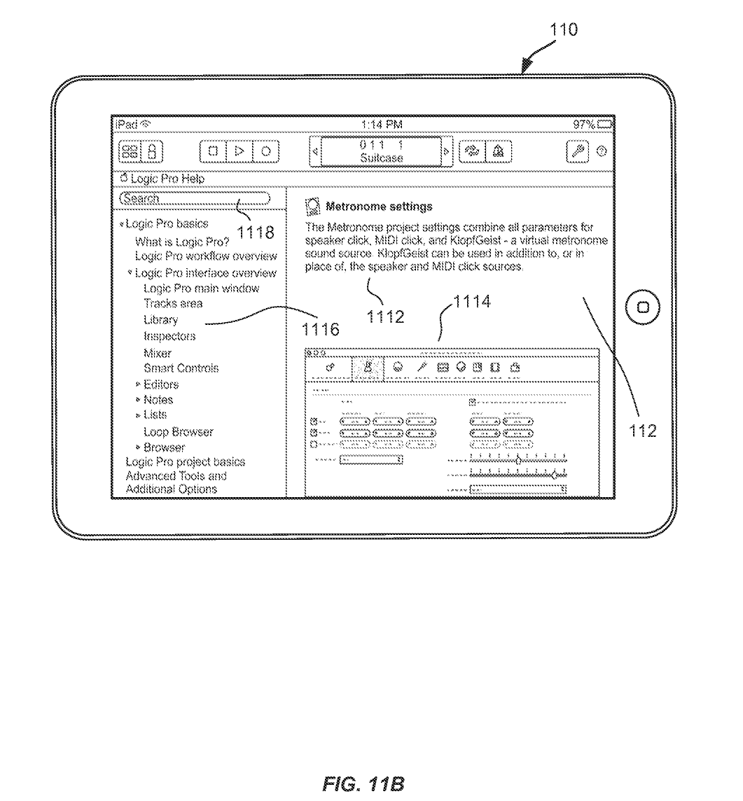

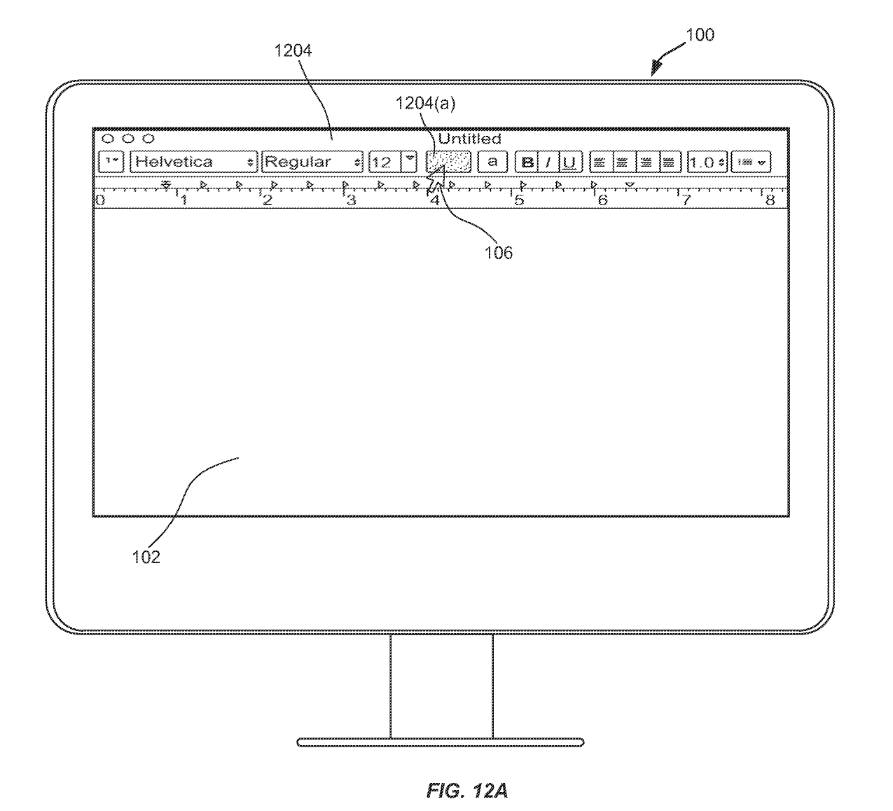

In FIG. 10, remote device 110 is shown displaying user interface 112 for an application related to Logic Pro® which is a digital audio workstation (DAW) and MIDI sequencer application provided by Apple Inc. of Cupertino, Calif. As shown in FIG. 10, user interface 112 can include a GUI element 1002 that can be selected or otherwise interacted with to initiate the reference information mode on remote device 110. For instance, if remote device 110 includes a touchscreen, a user can provide a gesture such as a single-tap at the location of element 1002 in user interface 112. In some embodiments, element 1002 can be selected via input from a mouse, trackpad, or any other suitable input device. As described above, upon activation of the reference information mode, remote device 110 can scan a connected network for host devices that are available for pairing. In some embodiments, an “available” host device can be a device that is connected to the same network as remote device 110 and that is executing the same application or a related application. For instance, host device 110 as depicted in FIG. 10 can scan its network for connected host devices that are running the Logic Pro® application. Such an available host device is illustrated in FIG. 11A as host device 100. Pairing of remote device 110 and host device 100 can be accomplished in a number of different ways as described in further detail above.

In FIG. 11A, host device 100 is paired with remote device 110 via communication link 108 (shown in FIGS. 1-9), and is shown displaying user interface 102 of the Logic Pro® application. As further shown in FIG. 11A, user interface 102 can include control elements 1104 and, specifically, control element 1104(a) which corresponds to a “metronome settings” functionality. Selection element 106 (i.e. a pointer in this example) can also be displayed by host device 100. In FIG. 11A, selection element 106 has been moved onto control element 1104(a) in response to received input (e.g., mouse input, trackpad input, etc.) provided by the user. Upon detecting that selection element 106 is hovering over (and/or pointing to) control element 1104(a), host device 100 can retrieve an identifier for control element 1104(a). For instance, host device 100 can identify a tag embedded within control element 1104(a) that is unique with respect to some or all of the control elements associated with the Logic Pro® application. This identifier can then be transmitted to remote device 110 via communication link 108.

The unique tag received by remote device 110 can be used to identify reference information corresponding to the control element 1104(a). As described above, the identifier can be cross-referenced with reference information stored in a database (e.g., a data table that maps identifiers to corresponding reference information), and reference information specifically corresponding to control element 1104(a) can be retrieved.

FIG. 11B illustrates remote device 110 displaying the identified reference information corresponding to control element 1104(a) in user interface 112. As shown in FIG. 11B, the reference information can include text-based content 1112 and multimedia content 1114 describing the functionality of control element 1104(a), i.e. the metronome settings functionality. This reference information may have been retrieved from a user manual for the Logic Pro® application stored on (or otherwise accessible to) remote device 110. In this example, text-based content 1112 provides a name and description of control element 1104(a), and the multimedia content 1114 provides an image of the metronome settings user interface that is displayed in response to the user selecting control element 1104(a). In some embodiments, reference information can include a functional interface by which a user can interact with an application or operating system. For instance, multimedia content 1114 can be a functional interface by which the user can adjust the metronome settings for the current audio project.

As further shown in FIG. 11B, links 1116 are also displayed. In this example, links 1116 provide access to sections of the Logic Pro® application user manual that correspond to general application overviews and additional topics related to the metronome settings functionality. In FIG. 11B, a search field 1118 is further provided to facilitate keyword-based searching of the application user manual.

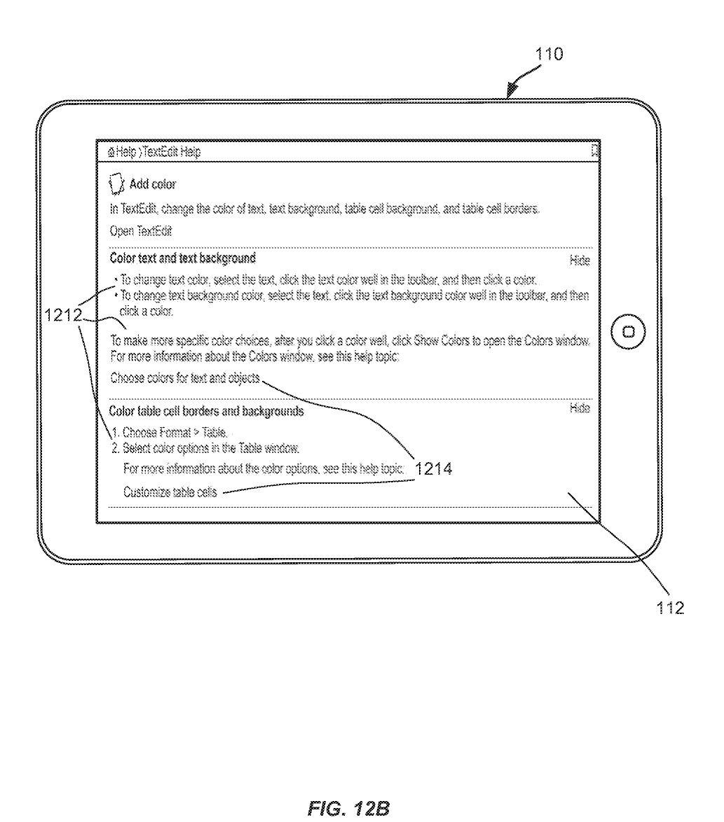

FIGS. 12A-12B provide an example of remote device 110 displaying reference information corresponding to a control element being displayed on host device 100 in the context of a word processor application.

In FIG. 12A, host device 100 is shown displaying user interface 102 of the TextEdit application provided by Apple Inc. In this example, the paired remote device 110 can be executing the same TextEdit application, a general help application, or other suitable application. As further shown in FIG. 12A, user interface 102 includes control elements 1204 displayed in a toolbar, and specifically control element 1204(a) which corresponds to the “add color” functionality. In FIG. 12A, selection element 106 (i.e. a pointer in this example) has been moved onto control element 1204(a) in response to received user input. In response, host device 100 can retrieve an identifier for control element 1204(a) such as, for instance, a unique embedded tag. The identifier can then be transmitted to remote device 110 via communication link 108.

The identifier received by remote device 110 can be used to identify reference information corresponding to control element 1204(a). For instance, remote device 110 can cross-reference the identifier with a stored data table to retrieve reference information specifically corresponding to the add color functionality, such as the pertinent sections of a stored user manual for the TextEdit application.

In FIG. 12B, the identified reference information is displayed by remote device 110 in user interface 112. In this example, the reference information corresponding to control element 1204(a) includes text-based content 1212 and links 1214. The text based content 1212 provides information about the add color functionality such as step-by-step instructions for changing the color of text, background color, and the color of table cell backgrounds and borders in the TextEdit application. Displayed links 1214 can be selected by the user, and can provide additional help-related content related to the add color functionality. For instance, selecting any of links 1214 can cause a related portion of the user manual for the TextEdit application to be displayed in user interface 112 of remote device 110.

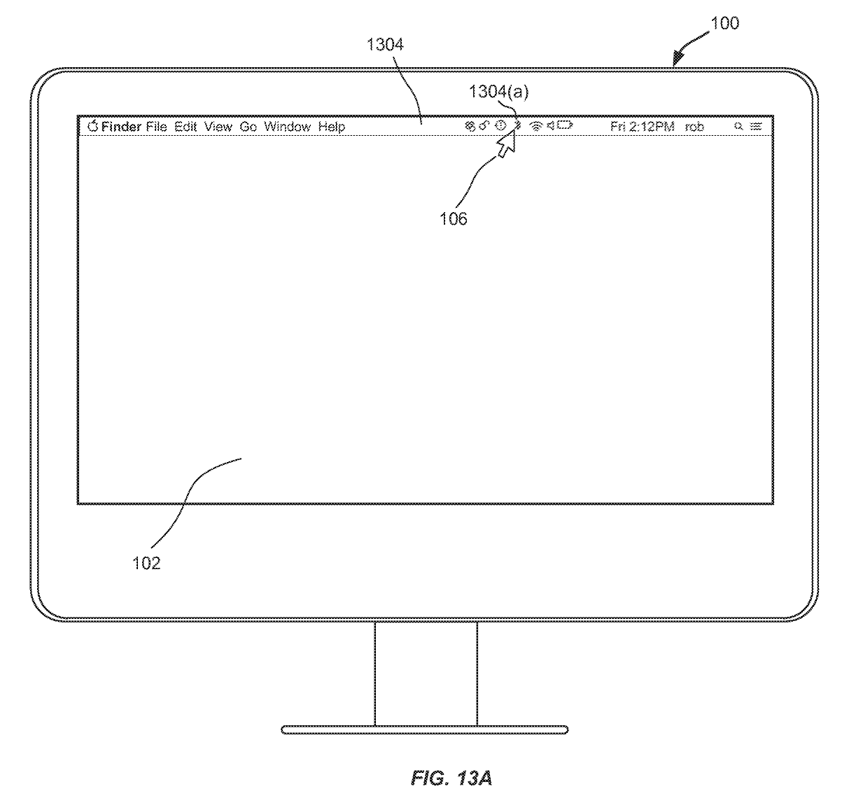

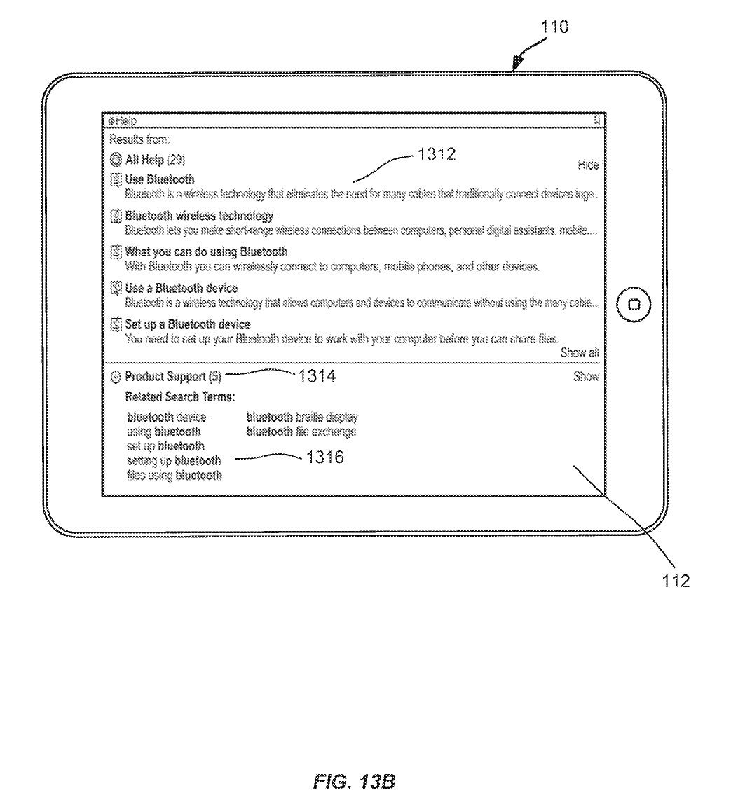

FIGS. 13A-13B provide an example of remote device 110 displaying reference information corresponding to a control element being displayed on host device 100 in the context of an operating system.

In FIG. 13A, host device 100 is shown displaying user interface 102 of the Mac OS X® operating system provided by Apple Inc. In this example, the paired remote device 110 can also be executing the OS X® operating system (or a related operating system), and can also be executing a general help application or other suitable application. As further shown in FIG. 13A, user interface 102 includes control elements 1304 displayed in a toolbar, and specifically control element 1304(a) which corresponds to a Bluetooth functionality. In FIG. 13A, selection element 106 (a pointer in this example) has been moved onto (i.e. is pointing to) control element 1304(a) in response to received user input. In response, host device 100 can retrieve an identifier for control element 1304(a). As described herein, such a determination may involve retrieving a unique tag embedded within control element 1304(a) in user interface 102. The retrieved identifier can then be transmitted to remote device 110 via communication link 108.

The identifier can be used by remote device 110 to identify reference information corresponding to control element 1304(a), such as Mac OS X® user manual entries that relate to the Bluetooth functionality. In FIG. 13B, the identified reference information is displayed by remote device 110 in user interface 112. In this example, the reference information includes a series of links 1312 to different portions of the user manual that relate to the Bluetooth functionality. As shown in FIG. 13B, the displayed reference information further includes a link 1314 to product support content, and keyword-based search terms 1316 that can be used to locate further information regarding Bluetooth functionality.

As noted above, the particular applications and operating systems discussed with respect to FIGS. 10-13B are intended to be non-limiting, as embodiments apply to any suitable application or operating system. Moreover, the combinations of text-based content, multimedia content, links, and other content included in the reference information displayed by host device 110 in the above-described examples are not intended to be limiting. Any suitable content relating to control elements can be displayed as reference information in various embodiments.

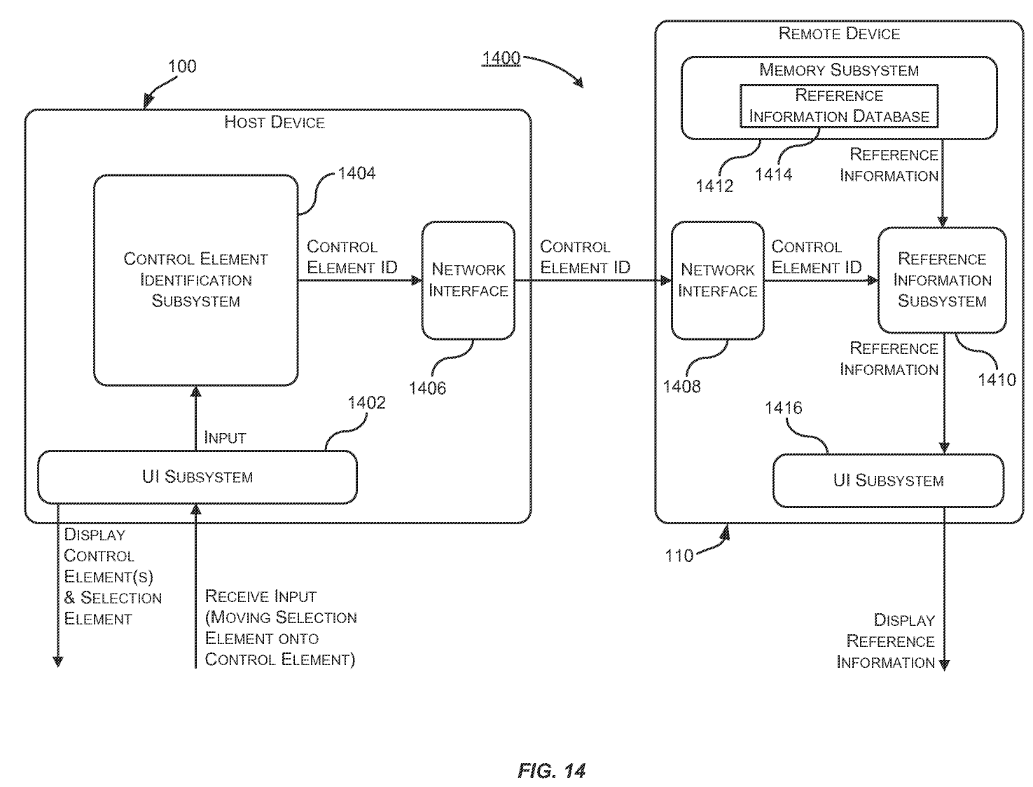

FIG. 14 illustrates a simplified diagram of a system 1400 that may incorporate one or more embodiments of the invention. In the embodiments depicted in FIG. 14, system 1400 includes host device 100 and remote device 110 which each include multiple subsystems. For instance, host device 100 includes a UI subsystem 1402, a control element identification system 1404, and a network interface 1406. Remote device 110, in FIG. 14, includes a network interface 1408, a reference information system 1410, a UI subsystem 1416, and a memory subsystem 1412 including a reference information database 1414. One or more communication paths may be provided enabling one or more of the subsystems to communicate with and exchange data with one another. One or more of the subsystems depicted in FIG. 14 may be implemented in software, in hardware, or combinations thereof. In some embodiments, the software may be stored on a transitory or non-transitory medium and executed by one or more processors of system 1400.

It should be appreciated that system 1400 depicted in FIG. 14 may have other components than those depicted in FIG. 14. Further, the embodiment shown in FIG. 14 is only one example of a system that may incorporate one or more embodiments of the invention. In some other embodiments, system 1400 may have more or fewer components than that shown in FIG. 14, may combine two or more components, or may have a different configuration or arrangement of components.

UI subsystem 1402 and UI subsystem 1416 may each provide an interface that allows a user to interact with host device 100 and remote device 110, respectively. UI subsystems 1402, 1416 may output information to the user. For instance, UI subsystems 1402, 1416 may each include a display device such as a monitor or a screen. UI subsystems 1402, 1416 may also enable the user to provide inputs to host device 100 and remote device 110. In some embodiments, one or both of UI subsystems 1402, 1416 may include a touch-sensitive interface (i.e. a touchscreen) that can both display information to a user and also receive inputs from the user. For instance, in some embodiments, one or both of UI subsystems 1402,1416 can receive touch input from a user. Such touch input may correspond to one or more gestures, such as a drag, swipe, pinch, flick, single-tap, double-tap, rotation, multi-touch gesture, and the like. In some embodiments, one or both of UI subsystems 1402, 1416 may include one or more input devices that allow a user to provide additional inputs to host device 100 and/or remote device 110 such as, without limitation, a mouse, a keyboard, or other input device. In certain embodiments, one or both of UI subsystems 1402, 1416 may further include a microphone (e.g., an integrated microphone or an external microphone communicatively coupled to host device 100 and/or remote device 110) and voice recognition circuitry configured to facilitate audio-to-text translation and to translate audio input provided by the user into commands that cause host device 100 and/or remote device 110 to perform various functions. In some embodiments, one or both of UI subsystems 1402, 1416 may further include eye gaze circuitry configured to translate eye gaze input provided by the user into commands that cause host device 100 and/or remote device 110 to perform various functions.

Network interfaces 1406, 1408 can facilitate a communication link (e.g., communication link 108 shown in FIGS. 1-9) between host device 100 and remote device 110. In some embodiments, one or both of network interfaces 1406, 1408 can include radio frequency (RF) transceiver components for accessing wireless data networks such as WiFi (IEEE 802.11 family standards), 4G, 3G, EDGE, or any other suitable wireless data network. In some embodiments, one or both of network interfaces 1406, 1408 can include components for short-range wireless networking using, for instance, Bluetooth standards. In some embodiments, one or both of network interfaces 1406, 1408 can provide wired network connectivity (e.g., Ethernet) in addition to or instead of a wireless interface. Network interfaces 1406, 1408 can be implemented using any suitable combination of hardware (e.g., driver circuits, antennas, modulators/demodulators, encoders/decoders, analog and/or digital signal processing components, in addition to any suitable software components.

Memory subsystem 1412 of remote device 110 may be configured to store data and instructions used by some embodiments of the invention. In some embodiments, memory subsystem 1412 may include volatile memory such as random access memory or RAM (sometimes referred to as system memory). Instructions or code or programs that are executed by one or more processors of remote device 110 may also be stored in the RAM. Memory subsystem 1412 may also include non-volatile memory such as one or more storage disks or devices, flash memory, or other non-volatile memory devices. In some embodiments, memory subsystem 1412 can store reference information database 1414. In some embodiments, reference information database 1414 can store reference information as described herein for control elements of various applications and/or operating systems. Such reference information may be stored in the form of a data table that maps identifiers of control elements to corresponding reference information (e.g., pertinent portions of a user manual). In some embodiments, all or a portion of reference information database 1414 can be stored external to remote device 110 (e.g., on a web-based server computer).

In some embodiments, UI subsystem 1402, control element identification system 1404, and network interfaces 1406, 1408, working in cooperation, may be responsible for determining an identifier of a control element displayed by host device 100 and transmitting the identifier to remote device 110. For instance, UI subsystem 1402 can display one or more control elements of an application and/or operating system user interface, and a selection element, on a display screen. UI subsystem can subsequently receive an input (e.g., mouse, trackpad, or other input) corresponding to moving the selection element onto a control element. The received input can be communicated by UI subsystem 1402 to control element identification system 1404, which may then determine an identifier of the control element. For instance, as described herein, control element identification subsystem 1404 can retrieve a unique tag embedded within the control element. The identifier of the control element can then be transmitted from host device 100 to remote device 110 via network interfaces 1406, 1408.

In some embodiments, UI subsystem 1416, reference information subsystem 1410, and memory subsystem 1412, working in cooperation, may be responsible for using the received identifier of the control element to identify reference information corresponding to the control element and to then display the identified reference information. For instance, upon receipt of the identifier at network interface 1408, reference information subsystem 1410 can cross-reference the identifier with reference information stored in reference information database 1414 of memory subsystem 1412. Upon identifying reference information corresponding to the control element, reference information subsystem can cooperate with UI subsystem 1416 to display the identified reference information (e.g., on a display screen of remote device 110).

In some embodiments, some or all of the components of system 1400, working in cooperation, can perform a number of additional functions described herein. For instance, UI subsystem 1416 and reference information subsystem 1410 can work in cooperation to activate a reference information mode of remote device 110 that facilitates pairing and the receipt of identifiers from host device 100. In some embodiments, if host device 100 detects that the selection element has been moved from the first control element to a second control element, an identifier of the second control element can be determined by control element identification subsystem 1404 and transmitted to remote device 110 via network interfaces 1406, 1408. Upon receipt by remote device 110, reference information subsystem can access reference information database 1414 of memory subsystem 1412 to identify reference information corresponding to the second control element, and can cooperate with UI subsystem 1416 to display the identified reference information. In some embodiments, reference information subsystem 1410 can determine whether a screen lock mode of remote device 110 is activated. In such embodiments, when the identifier of the second control element is received, reference information subsystem 1410 can cooperate with UI subsystem 1416 to maintain the display of reference information corresponding to the first control element.

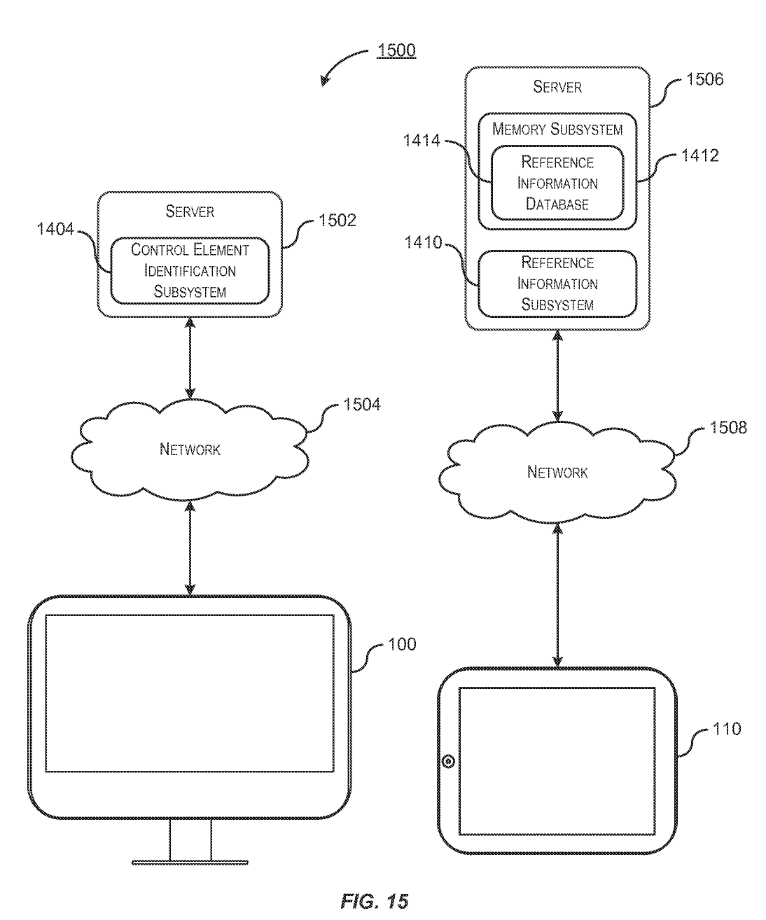

System 1400 depicted in FIG. 14 may be provided in various configurations. In some embodiments, system 1400 may be configured as a distributed system where one or more components of system 1400 are distributed across one or more networks in the cloud. FIG. 15 illustrates a simplified diagram of a distributed system 1500 that may incorporate one or more embodiments of the invention. In the embodiments depicted in FIG. 15, control element identification subsystem 1404 is provided in a server 1502 that is communicatively coupled with host device 100 via a network 1504. Similarly, reference information subsystem 1410 and memory subsystem 1412 storing reference information database 1414 are provided in a server 1506 that is communicatively coupled to host device 110 via a network 1508.

One or both of networks 1504, 1508 may include one or more communication networks, which could be the Internet, a local area network (LAN), a wide area network (WAN), a wireless or wired network, an Intranet, a private network, a public network, a switched network, or any other suitable communication network. One or both of networks 1504, 1508 may include many interconnected systems and communication links including but not restricted to hardwire links, optical links, satellite or other wireless communications links, wave propagation links, or any other ways for communication of information. Various communication protocols may be used to facilitate communication of information via networks 1504, 1508 including but not restricted to TCP/IP, HTTP protocols, extensible markup language (XML), wireless application protocol (WAP), protocols under development by industry standard organizations, vendor-specific protocols, customized protocols, and others.

In the configuration depicted in FIG. 15, reference information can be displayed on remote device 110, the reference information corresponding to a control element displayed on host device 100. For instance, host device 100 can display one or more control elements of a user interface and a selection element. Input can be received corresponding to moving the selection element onto a control element. The touch input can be communicated to control element identification subsystem 1404 via network 1504. Control element identification subsystem 1404 can then determine an identifier of the control element as described herein. In some embodiments, the identifier can be transmitted to host device 100 which can then transmit the identifier to remote device 110. In such embodiments, remote device 110 can transmit the received identifier to reference information subsystem 1410 via network 1508. In other embodiments, the identifier of the control element can be communicated directly from server computer 1502 to server computer 1506. Upon receipt of the identifier, reference information subsystem 1410 can cross-reference the identifier with reference information stored in reference information database 1414. Reference information corresponding to the control element can be transmitted to remote device 110 via network 1508. Remote device 110 can then display the received reference information.

As described above with respect to system 1400 illustrated in FIG. 14, some or all of the components of servers 1502, 1506 can work cooperatively with host device 100 and remote device 110 to perform a number of additional functions such as activating a reference information mode of remote device 110, identifying and displaying reference information for additional control elements, maintaining the display of reference information corresponding to a first control element when a screen lock mode of remote device 110 is activated prior to remote device 110 receiving an identifier of a second control element, and any other additional functions described herein according to various embodiments.

In the configuration depicted in FIG. 15, control element identification subsystem 1404 is remotely located from host device 100, and reference information subsystem 1410 and memory subsystem 1412 are remotely located from remote device 110. In some embodiments, one or both of servers 1502, 1506 may facilitate the display of reference information as described herein for multiple host devices and/or remote devices. The multiple devices may be served concurrently or in some serialized manner. In some embodiments, the services provided by one or both of servers 1502, 1506 may be offered as web-based or cloud services or under a Software as a Service (SaaS) model.

It should be appreciated that various different distributed system configurations are possible, which may be different from distributed system 1500 depicted in FIG. 15. The embodiment shown in FIG. 15 is thus only one example of a distributed system and is not intended to be limiting. For instance, in some embodiments, networks 1504, 1508 can be a single network. Moreover, in some embodiments, servers 1502, 1506 can be a single server computer or multiple server computers communicatively coupled by one or more networks.

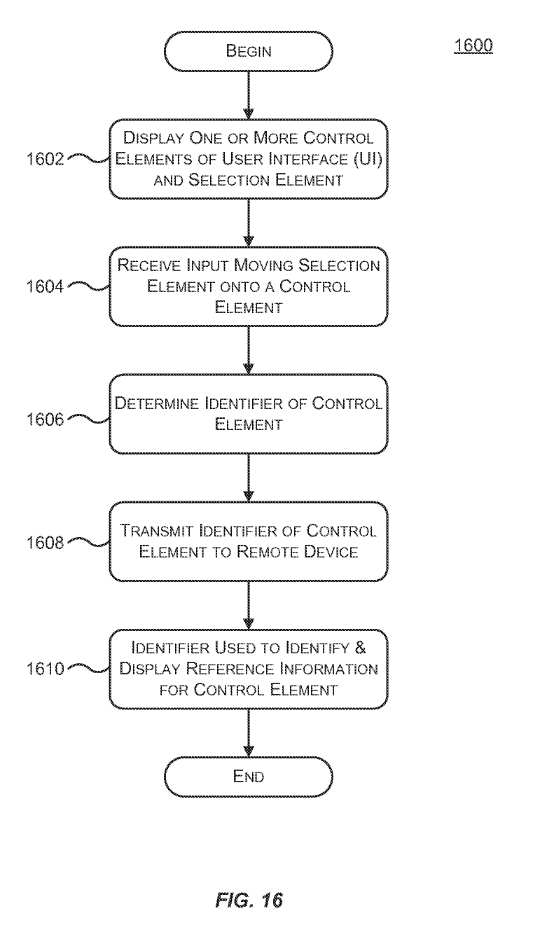

FIG. 16 illustrates a simplified flowchart depicting a method 1600 of displaying reference information on a remote device, the reference information corresponding to a control element displayed on a host device according to some embodiments. The processing depicted in FIG. 16 may be implemented in software (e.g., code, instructions, and/or a program) executed by one or more processors, hardware, or combinations thereof. The software may be stored on a non-transitory computer-readable storage medium (e.g., as a computer-program product). The particular series of processing steps depicted in FIG. 16 is not intended to be limiting.

As illustrated in FIG. 16, at step 1602, a host device can display one or more control elements of a user interface and a selection element. The one or more control elements may be GUI elements that each correspond to a particular functionality. In some embodiments, some or all of the displayed control elements may correspond to functionalities of an application being executed by the host device. In some embodiments, some or all of the displayed control elements may not be tied to a particular application. For instance, any of the one or more control elements may correspond to an application-independent functionality of an operating system running on the host device.

The selection element displayed by the host device may be used to select, or otherwise interact with, the one or more control elements displayed in the user interface. For instance, the selection element can be a GUI element such as a pointer or cursor that can be moved about the user interface in response to received input.

At step 1604, an input can be received by the host device, the input corresponding to moving the selection element onto a control element. For instance, a user can utilize a mouse or trackpad to move a pointer to a position in the user interface where the pointer is overlapping (e.g., hovering over) the control element. In various embodiments, the selection element can be moved onto the control element using any other suitable form of input such as voice input, eye gaze input, and the like.

At step 1606, in response to detecting that the selection element has been moved over the control element, the host device can determine an identifier of the control element. In some embodiments, the identifier of the control element can be a tag embedded within the control element. As described herein, the identifier can uniquely identify the control element with respect to the one or more control elements displayed in the user interface.

At step 1608, the host device can transmit the determined identifier of the control element to a remote device. The identifier can be transmitted via a communication link previously established between the host device and the remote device. The communication link can be any suitable wireless or wired connection. As described in further detail above, the communication link can be initially established as part of a pairing process wherein a reference information mode of the remote device is activated. The reference information mode can cause the remote device to identify and display one or more host devices with which a communication link can be made. In such embodiments, the displayed one or more host devices can include the host device, and the remote device can receive an input (e.g., user input) corresponding to a selection of the host device for pairing.

At step 1610, the identifier can be used by the remote device to identify and display reference information corresponding to the control element. For instance, the remote device can cross-reference the identifier received from the host device with reference information stored in a database that is internal or external to the remote device. The reference information can include any suitable information relating to the control element such as content relating to the functionality of the control element (e.g., portions of a user manual related to the control element). The reference information displayed by the remote device can include any suitable content such as any combination of text, video, audio, images, links (e.g., hyperlinks), and the like.

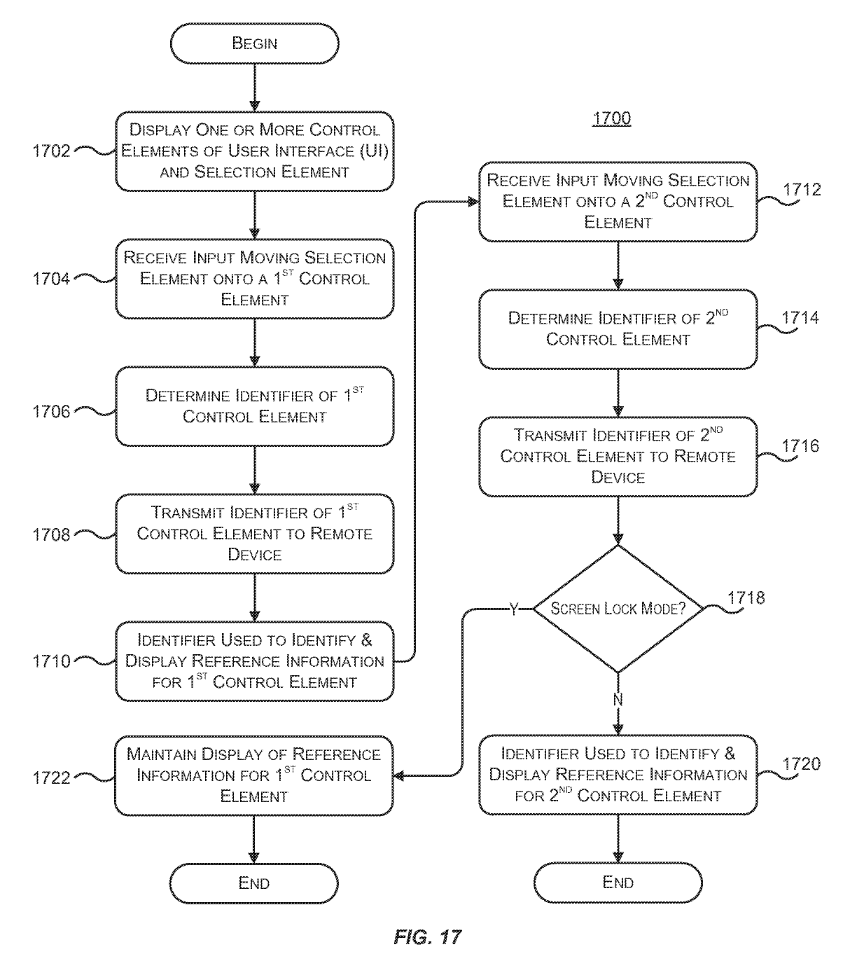

In some embodiments, upon reviewing the reference information corresponding to the control element as displayed by the remote device, a user may want to review reference information corresponding to another control element of the user interface displayed by the host device. FIG. 17 illustrates a simplified flowchart depicting a method 1700 of displaying reference information on a remote device, the reference information corresponding to a second control element displayed on a host device according to some embodiments.

In method 1700, steps 1702-1710 may be the same or similar to steps 1602-1610 of method 1600 illustrated in FIG. 16. Thus, in some embodiments, further details regarding steps 1702-1710 are described throughout this disclosure, including in the above description of steps 1602-1610.

At step 1712, an input can be received at the host device, the input corresponding to moving the selection element from the first control element (e.g., the control element described in method 1600) to a second control element of the user interface displayed by the host device. For instance, the user can utilize a mouse, trackpad, or any other suitable input device to move a pointer from the first control element onto the second control element such that the pointer is overlapping (e.g., hovering over) the second control element.

At step 1714, in response to detecting that the selection element has been moved over the second control element, the host device can determine an identifier of the second control element. In some embodiments, the identifier of the second control element can be a unique tag embedded within the second control element.

At step 1716, the host device can transmit the determined identifier of the second control element to the remote device. As described herein, the identifier of the second control element can be transmitted via a communication link previously established between the host device and the remote device.

At decision 1718, the remote device receives the identifier of the second control element, and then determines whether a screen lock mode of the remote device has been activated. In some embodiments, the remote device can receive an input (e.g., user input) corresponding to an initiation of the screen lock mode. The screen lock mode can cause the remote device to maintain the display of the reference information corresponding to the first control element in response to receiving the identifier of the second control element from the host device. Thus, if remote device determines at decision 1718 that the screen lock mode has been activated, method 1700 can proceed to step 1722 wherein the remote device maintains the display of the reference information corresponding to the first control element. If the remote device determines at step 1718 that the screen lock mode has not been activated, method 1700 can proceed to step 1720.

At step 1720, the remote device can use the identifier of the second control element to identify and display reference information corresponding to the second control element. For instance, the remote device can cross-reference the identifier with reference information stored in the database. The reference information can include any suitable information relating to the second control element such as content relating to the functionality of the second control element (e.g., relevant portions of a user manual). The reference information corresponding to the second control element can be displayed by the remote device as any suitable content.

As described herein, embodiments of the invention can relate to a remote device displaying reference information corresponding to a control element displayed on a host device. By displaying such reference information on the remote device instead of the host device, the display area of the host device can be unobstructed. Thus, the functionalities of the application and/or operating system being executed by the host device can be unaffected. Moreover, by use of the transmitted identifier, the reference information can be immediately displayed to the user by the remote device in response to the user moving the selection element onto the corresponding control element. Thus, users can be provided with information about the functionality of a control element in a quick and convenient manner, thereby reducing the need for a “trial by error” approach.

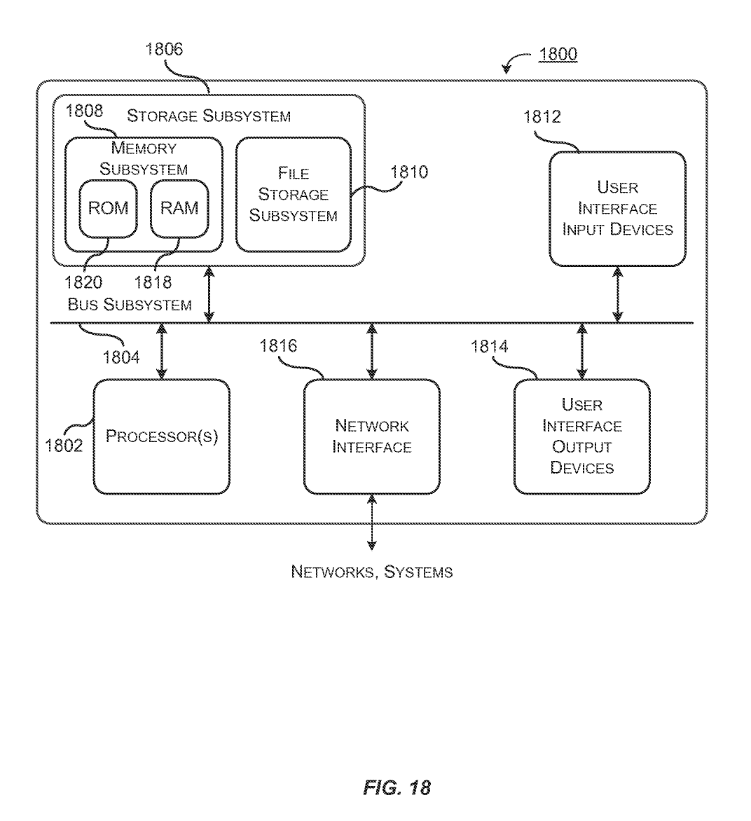

As described above, system 1400 illustrated in FIG. 14 may incorporate embodiments of the invention. System 1400 may display reference information on a remote device, the reference information corresponding to a control element displayed on a host device. System 1400 may incorporate one or more of the exemplary user interfaces described above with respect to FIGS. 1-13B, and/or may further provide one or more of the method steps described above with respect to FIGS. 16-17. Moreover, system 1400 may be incorporated into various systems and devices. For instance, FIG. 18 illustrates a simplified block diagram of a computer system 1800 that may incorporate components of a system for displaying reference information on a remote device, the reference information corresponding to a control element displayed on a host device according to some embodiments. In some embodiments, one or both of a host device and remote device can incorporate some or all the components of computer system 1800. As shown in FIG. 18, computer system 1800 may include one or more processors 1802 that communicate with a number of peripheral subsystems via a bus subsystem 1804. These peripheral subsystems may include a storage subsystem 1806, including a memory subsystem 1808 and a file storage subsystem 1810, user interface input devices 1812, user interface output devices 1814, and a network interface subsystem 1816.

Bus subsystem 1804 provides a mechanism for letting the various components and subsystems of computer system 1800 communicate with each other as intended. Although bus subsystem 1804 is shown schematically as a single bus, alternative embodiments of the bus subsystem may utilize multiple busses.

Processor 1802, which can be implemented as one or more integrated circuits (e.g., a conventional microprocessor or microcontroller), controls the operation of computer system 1800. One or more processors 1802 may be provided. These processors may include single core or multicore processors. In various embodiments, processor 1802 can execute a variety of programs in response to program code and can maintain multiple concurrently executing programs or processes. At any given time, some or all of the program code to be executed can be resident in processor(s) 1802 and/or in storage subsystem 1806. Through suitable programming, processor(s) 1802 can provide various functionalities described above.

Network interface subsystem 1816 provides an interface to other computer systems and networks. Network interface subsystem 1816 serves as an interface for receiving data from and transmitting data to other systems from computer system 1800. For example, network interface subsystem 1816 may enable computer system 1800 to connect to one or more devices via the Internet. In some embodiments network interface 1816 can include radio frequency (RF) transceiver components for accessing wireless voice and/or data networks (e.g., using cellular telephone technology, advanced data network technology such as 3G, 4G or EDGE, WiFi (IEEE 802.11 family standards, or other mobile communication technologies, or any combination thereof), GPS receiver components, and/or other components. In some embodiments network interface 1816 can provide wired network connectivity (e.g., Ethernet) in addition to or instead of a wireless interface.

User interface input devices 1812 may include a keyboard, pointing devices such as a mouse or trackball, a touchpad or touch screen incorporated into a display, a scroll wheel, a click wheel, a dial, a button, a switch, a keypad, audio input devices such as voice recognition systems, microphones, eye gaze systems, and other types of input devices. In general, use of the term “input device” is intended to include all possible types of devices and mechanisms for inputting information to computer system 1800. For example, in an iPhone®, user input devices 1812 may include one or more buttons provided by the iPhone® and a touchscreen which may display a software keyboard, and the like.

User interface output devices 1814 may include a display subsystem, indicator lights, or non-visual displays such as audio output devices, etc. The display subsystem may be a cathode ray tube (CRT), a flat-panel device such as a liquid crystal display (LCD), a projection device, a touch screen, and the like. In general, use of the term “output device” is intended to include all possible types of devices and mechanisms for outputting information from computer system 1800. For example, a software keyboard may be displayed using a flat-panel screen.

Storage subsystem 1806 provides a computer-readable storage medium for storing the basic programming and data constructs that provide the functionality of some embodiments. Storage subsystem 1806 can be implemented, e.g., using disk, flash memory, or any other storage media in any combination, and can include volatile and/or non-volatile storage as desired. Software (programs, code modules, instructions) that when executed by a processor provide the functionality described above may be stored in storage subsystem 1806. These software modules or instructions may be executed by processor(s) 1802. Storage subsystem 1806 may also provide a repository for storing data used in accordance with the present invention. Storage subsystem 1806 may include memory subsystem 1808 and file/disk storage subsystem 1810.

Memory subsystem 1808 may include a number of memories including a main random access memory (RAM) 1818 for storage of instructions and data during program execution and a read only memory (ROM) 1820 in which fixed instructions are stored. File storage subsystem 1810 provides persistent (non-volatile) memory storage for program and data files, and may include a hard disk drive, a floppy disk drive along with associated removable media, a Compact Disk Read Only Memory (CD-ROM) drive, an optical drive, removable media cartridges, and other like memory storage media.

Computer system 1800 can be of various types including a personal computer, a portable device (e.g., an iPhone®, an iPad®), a workstation, a network computer, a mainframe, a kiosk, a server or any other data processing system. Due to the ever-changing nature of computers and networks, the description of computer system 1800 depicted in FIG. 18 is intended only as a specific example. Many other configurations having more or fewer components than the system depicted in FIG. 18 are possible.

Embodiments can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a non-transitory computer-readable medium for execution by, or to control the operation of, data processing apparatus.

Various embodiments described above can be realized using any combination of dedicated components and/or programmable processors and/or other programmable devices. The various embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for interprocess communication, and different pairs of processes may use different techniques, or the same pair of processes may use different techniques at different times. Further, while the embodiments described above may make reference to specific hardware and software components, those skilled in the art will appreciate that different combinations of hardware and/or software components may also be used and that particular operations described as being implemented in hardware might also be implemented in software or vice versa.

The various embodiments are not restricted to operation within certain specific data processing environments, but are free to operate within a plurality of data processing environments. Additionally, although embodiments have been described using a particular series of transactions, this is not intended to be limiting.

Thus, although specific invention embodiments have been described, these are not intended to be limiting. Various modifications and equivalents are within the scope of the following claims.

What is claimed is:

1. A computer-implemented method, comprising:
displaying, by a host device, one or more control elements of a user interface and a selection element;
receiving an input corresponding to moving the selection element onto a control element;
determining an identifier of the control element; and
transmitting, from the host device to a remote device, the identifier of the control element, wherein when received by the remote device, the identifier is used to identify and display reference information corresponding to the control element.

2. The method of claim 1, wherein the remote device identifies the reference information by cross-referencing the identifier received from the host device with reference information stored in a database.

3. The method of claim 1, wherein the reference information includes content relating to the functionality of the control element.

4. The method of claim 1, wherein the identifier is a tag embedded within the control element.

5. The method of claim 1, further comprising:
prior to transmitting the identifier to the remote device, establishing a communication link with the remote device.

6. The method of claim 5, wherein the communication link is a wireless communication link.

7. The method of claim 1, wherein the control element is a first control element, and wherein the method further comprises:
after transmitting the identifier of the first control element to the remote device, receiving an input corresponding to moving the selection element onto a second control element;
determining an identifier of the second control element; and
transmitting, from the host device to the remote device, the identifier of the second control element, wherein when the identifier of the second control element is received by the remote device, the identifier of the second control element is used to identify and display reference information corresponding to the second control element.

8. The method of claim 1, wherein prior to receiving the identifier, the remote device receives an input corresponding to initiation of a reference information mode of an application.

9. The method of claim 5, wherein prior to establishing the communication link, the remote device identifies and displays one or more host devices with which a communication link can be made, the one or more host devices including the host device, and receives an input corresponding to a selection of the host device.

10. The method of claim 1, wherein the control element is a first control element, and wherein the remote device receives an input corresponding to initiation of a screen lock mode that causes the remote device to maintain the display of the reference information corresponding to the first control element in response to receiving an identifier of a second control element from the host device.

11. A computer-implemented system, comprising:
one or more data processors; and
one or more non-transitory computer-readable storage media containing instructions configured to cause the one or more processors to perform operations including:
displaying one or more control elements of a user interface and a selection element;
receiving an input corresponding to moving the selection element onto a control element;
determining an identifier of the control element; and
transmitting, to a remote device, the identifier of the control element, wherein when received by the remote device, the identifier is used to identify and display reference information corresponding to the control element.

12. The system of claim 11, wherein the remote device identifies the reference information by cross-referencing the identifier received from the host device with reference information stored in a database.

13. The system of claim 11, wherein the reference information includes content relating to the functionality of the control element.

14. The system of claim 11, wherein the identifier is a tag embedded within the control element.

15. The system of claim 11, wherein the operations further include:
prior to transmitting the identifier to the remote device, establishing a communication link with the remote device.

16. The system of claim 15, wherein the communication link is a wireless communication link.

17. The system of claim 11, wherein the control element is a first control element, and wherein the operations further include:
after transmitting the identifier of the first control element to the remote device, receiving an input corresponding to moving the selection element onto a second control element;
determining an identifier of the second control element; and
transmitting, to the remote device, the identifier of the second control element, wherein when the identifier of the second control element is received by the remote device, the identifier of the second control element is used to identify and display reference information corresponding to the second control element.

18. The system of claim 11, wherein prior to receiving the identifier, the remote device receives an input corresponding to initiation of a reference information mode of an application.

19. The system of claim 15, wherein the one or more data processors are associated with a host device, and wherein prior to establishing the communication link, the remote device identifies and displays one or more host devices with which a communication link can be made, the one or more host devices including the host device, and receives an input corresponding to a selection of the host device.

20. The system of claim 11, wherein the one or more data processors are associated with a host device, wherein the control element is a first control element, and wherein the remote device receives an input corresponding to initiation of a screen lock mode that causes the remote device to maintain the display of the reference information corresponding to the first control element in response to receiving an identifier of a second control element from the host device.

21. A computer-program product, tangibly embodied in a non-transitory machine-readable storage medium, including instructions configured to cause a data processing apparatus to:
display one or more control elements of a user interface and a selection element;
receive an input corresponding to moving the selection element onto a control element;
determine an identifier of the control element; and
transmit, to a remote device, the identifier of the control element, wherein when received by the remote device, the identifier is used to identify and display reference information corresponding to the control element.

22. The computer-program product of claim 21, wherein the remote device identifies the reference information by cross-referencing the identifier received from the host device with reference information stored in a database.

23. The computer-program product of claim 21, wherein the reference information includes content relating to the functionality of the control element.

24. The computer-program product of claim 21, wherein the identifier is a tag embedded within the control element.

25. The computer-program product of claim 21, wherein the instructions are further configured to cause the data processing apparatus to:
prior to transmitting the identifier to the remote device, establish a communication link with the remote device.

26. The computer-program product of claim 25, wherein the communication link is a wireless communication link.

27. The computer-program product of claim 21, wherein the control element is a first control element, and wherein the instructions are further configured to cause the data processing apparatus to:
after transmitting the identifier of the first control element to the remote device, receive an input corresponding to moving the selection element onto a second control element;
determine an identifier of the second control element; and
transmit, to the remote device, the identifier of the second control element, wherein when the identifier of the second control element is received by the remote device, the identifier of the second control element is used to identify and display reference information corresponding to the second control element.

28. The computer-program product of claim 21, wherein prior to receiving the identifier, the remote device receives an input corresponding to initiation of a reference information mode of an application.

29. The computer-program product of claim 25, wherein prior to establishing the communication link, the remote device identifies and displays one or more host devices with which a communication link can be made, the one or more host devices including the data processing apparatus, and receives an input corresponding to a selection of the data processing apparatus.

30. The computer-program product of claim 21, wherein the control element is a first control element, and wherein the remote device receives an input corresponding to initiation of a screen lock mode that causes the remote device to maintain the display of the reference information corresponding to the first control element in response to receiving an identifier of a second control element from the data processing apparatus.
